(19) United States
(12) Patent Application Publication
(10) Pub. No.: US 2014/0191856 A1
(43) Pub. Date: Jul. 10, 2014

(54) Home Appliance and Mobile Device

(71) Applicant: LG Electronics Inc., Seoul (KR)

(72) Inventors: Sanghun CHO, Changwon-si (KR); Hyocheol JEONG, Changwon-si (KR); Yanghwan KIM, Changwon-si (KR); Jongmi CHOI, Changwon-si (KR)

(73) Assignee: LG Electronics Inc., Seoul (KR)

(21) Appl. No.: 14/149,456

(22) Filed: Jan. 7, 2014

(30) Foreign Application Priority Data
Jan. 7, 2013 (KR) 10-2013-0001765
Jan. 7, 2013 (KR) 10-2013-0001766

(51) Int. Cl. G08C 19/00; H04L 12/28

(52) U.S. Cl. CPC G08C 19/00; H04L 12/2825
USPC 340/12.54

(57) ABSTRACT

A home appliance including a communication unit connected to and in communication with external devices; a display unit displaying, on a display screen, information about an external device, among the external devices, which is in communication with the communication unit; and a control unit controlling the display unit.

### CROSS-REFERENCE TO RELATED APPLICATIONS

The present application claims priority under 35 U.S.C. 119 and 35 U.S.C. 365 to Korean Patent Application No. 10-2013-0001766 (filed on Jan. 7, 2013) and Korean Patent Application No. 10-2013-0001765 (filed on Jan. 7, 2013), each of which is hereby incorporated by reference in its entirety.

### BACKGROUND

The present disclosure relates to a home appliance and mobile device.

Generally, the home appliance may include a display unit for displaying information. One limitation of the home appliance is that it displays only its information on the display unit and fails to display information regarding other home appliances.

Another limitation of the home appliance is that it only displays its information on the display unit and fails to share its information with other home appliances or content possessed by other home appliances.

### SUMMARY

In one embodiment, a home appliance includes: a communication unit to connect and communicate with external devices; a display unit displaying, on a display screen, information about an external device, among the external devices, which is in communication with the communication unit; and a control unit controlling the display unit.

In another embodiment, a mobile terminal includes: a communication unit to connect and communicate with external devices; a display unit displaying, on a display screen, information about an external device, among the external devices, which is in communication with the communication unit; and a control unit controlling the display unit.

The details of one or more embodiments are set forth in the accompanying drawings and the description below. Other features will be apparent from the description and drawings, and from the claims.

### BRIEF DESCRIPTION OF THE DRAWINGS

FIG. 1 is a schematic diagram of a network system according to one embodiment of the present invention;

FIG. 2 is a schematic diagram of a home appliance configuring a network system according to one embodiment of the present invention;

FIG. 3 is an example of a display screen displayed on a display unit of a home appliance according to one embodiment of the present invention;

FIG. 4 illustrates how notice information for providing a notice of a state change on the screen of a display unit of one embodiment is displayed;

FIG. 5 illustrates how a specific display frame is selected on the screen of FIG. 3;

FIG. 6 illustrates a screen displayed on a display unit when the specific display frame is selected in FIG. 5;

FIG. 7 illustrates how a specific display frame is touched for a certain time on the screen of a display unit of one embodiment of the present invention;

FIG. 8 illustrates a screen displayed on a display unit when the specific display frame is touched in FIG. 7;

FIG. 9 illustrates a screen after a first display frame is deleted in FIG. 8;

FIGS. 10 and 11 illustrate how the locations of display frames displayed on a display unit of one embodiment are changed;

FIG. 12 illustrate a screen displayed on a display unit when there is a communication-disconnected device or a communication-disabled device;

FIG. 13 is another example of a display screen displayed on a display unit of a home appliance according to one embodiment of the present invention;

FIG. 14 is still another example of a display screen displayed on a display unit of a home appliance according to one embodiment of the present invention;

FIG. 15 is an example of a main screen of a display screen displayed on a display unit of a home appliance according to one embodiment of the present invention;

FIG. 16 is an example of a display screen displayed on a display unit when a smart share option is selected from the screen of FIG. 15;

FIG. 17 is an example of a display screen displayed on a display unit when music file information is selected from the display screen of FIG. 16;

FIG. 18 illustrates how a selection window is displayed on a display screen when content category information is selected from FIG. 17;

FIG. 19 illustrates how a selection window is displayed on a display screen when an alignment selection button is selected from FIG. 17;

FIG. 20 is an example of a display screen displayed on a display unit when a photo is selected from a selection window displayed on the screen of FIG. 18;

FIG. 21 illustrates when a second display region of a display screen is aligned by folder;

FIG. 22 is an example of a display screen displayed on a display unit when a video is selected from a selection window displayed on the screen of FIG. 18;

FIG. 23 illustrates how a video is displayed on a display screen;

FIG. 24 illustrates how music file information is displayed on a display screen;

FIG. 25 illustrates how a video is displayed on a display screen; and

FIG. 26 is an example of a display screen displayed on a display unit when a refrigerator is selected from a first display region displayed on the screen of FIG. 17.

### DETAILED DESCRIPTION OF THE EMBODIMENTS

Reference will now be made in detail to the embodiments of the present disclosure, examples of which are illustrated in the accompanying drawings.

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense.

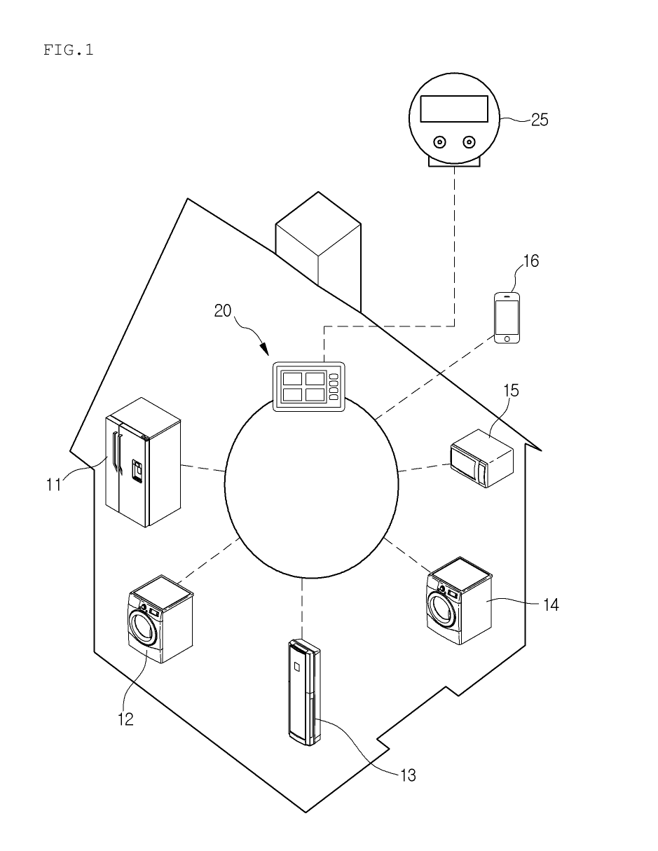

FIG. 1 is a schematic diagram of a network system according to one embodiment of the present invention.

Referring to FIG. 1, the network system according to one embodiment may include a plurality of home appliances that form a network, for example, at home (i.e., a home network).

The home appliances may include, for example, a refrigerator 11, a washing machine 12, an air conditioner 13, a drying machine 14, and a cooking device 15. Any home appliance may communicate with one or more other home appliances. Also, some or all of the home appliances may communicate with a mobile terminal 16. The mobile terminal 16 may be, for example, a smart phone

Also, one or more of the home appliances may communicate with an energy management unit 20. The energy management unit 20 may be a separate device or any one of the home appliances.

Further, one or more of the home appliances or the energy management unit 20 may communicate with an energy measurement unit 25 that may measure energy.

However, the network system according to one embodiment may not include the energy management unit or the energy measurement unit.

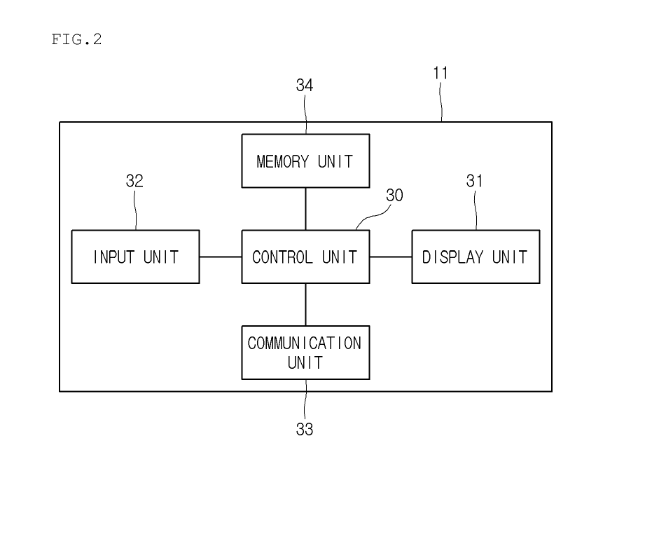

FIG. 2 is a schematic diagram of a home appliance configuring a network system according to one embodiment of the present invention.

As a home appliance for the network system, a refrigerator is described below as an example. Descriptions of the refrigerator may also be applied to other home appliances.

Referring to FIG. 2, the refrigerator 11 according to one embodiment may include a communication unit 33 for communicating with an external device.

A communication technique that the communication unit 33 uses may include at least one of Wi-Fi, ZigBee, Bluetooth, and internet techniques. There is no limitation on the communication technique that may be used.

The refrigerator 11 may include an input unit 32 that may input certain commands, a display unit 31 that displays operation information on the refrigerator 11 or information received from the communication unit 33, a memory unit 34 that stores control information or operation information on the refrigerator 11, and content related to the refrigerator 11 or external devices, and a control unit 30 that controls at least the display unit 31.

The control unit 30 may also control the overall operations of the refrigerator 11. As another example, a separate control may be further included. Specifically, the separate control unit may control the overall operations of the refrigerator 11 and the control unit 30 may control only the display unit 31.

When the display unit 31 includes a touch screen that may input commands by using a touch technique, a whole or portion of the input unit 32 may be included in the display unit 31. That is, a whole or portion of the input unit 32 may be implemented by the display unit 31.

The content stored in the memory 34 may include a video, a photo, and music.

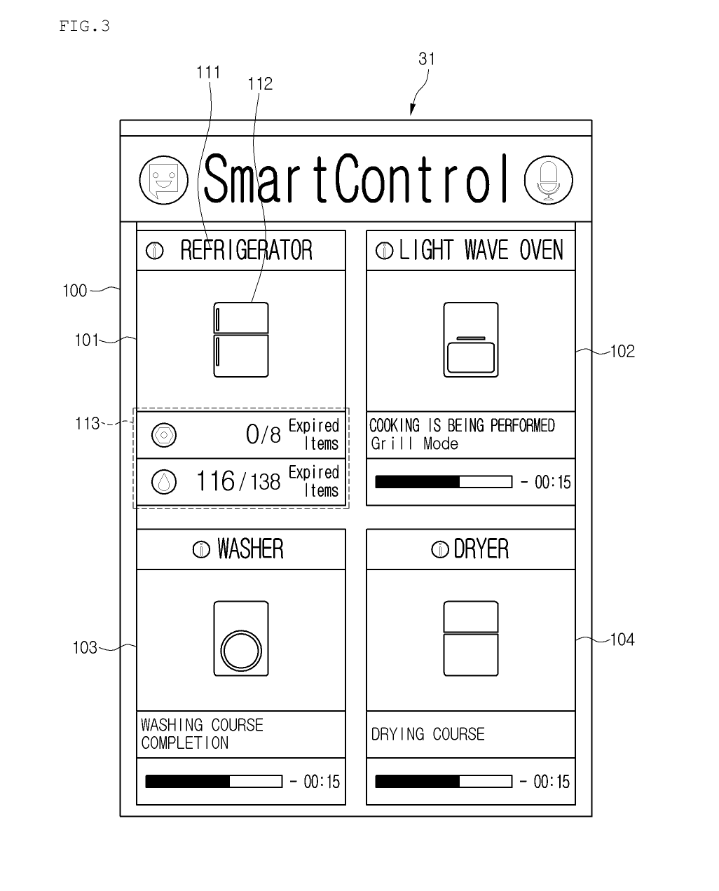

FIG. 3 is an example of a display screen displayed on a display unit of a home appliance according to one embodiment of the present invention.

Referring to FIG. 3, a screen 100 displaying information on one or more external communication-connected home appliances (hereinafter, referred to simply as “external devices”) may be displayed on the display unit 31 of the refrigerator 11 according to one embodiment.

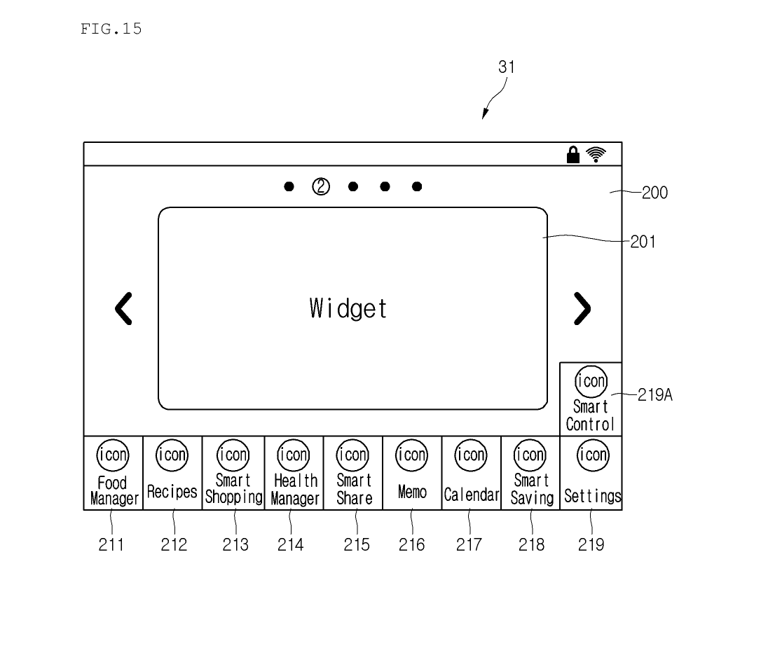

The screen 100 may be a main screen displayed when the refrigerator 11 is turned on, or a screen capable of being displayed when a specific button is selected from a separate main screen (See FIG. 15) to be described below.

The screen 100 may be divided into two or more display regions and the display unit 31 may display information regarding each communication-connected external devices, one per display region.

As an example, the screen 100 may include a first display region corresponding to its left upper part, a second display region located on the right of the first display region, a third display region located under the first display region, and a fourth display region located under the second display region.

Additionally, display frames 101 to 104 displaying information may be displayed on the first to fourth display regions, respectively.

Thus, as an example, four display frames 101 to 104 may be displayed on the screen 100. However, it should be noted that in one embodiment, there is no limitation on the number of display frames capable of being displayed on one screen 100.

If the number of external devices connected to the refrigerator 11 is more than that of the display frames capable of being displayed on the screen 100, scroll bars to move the screen 100 vertically or horizontally, a button to move the screen 100 horizontally, or a button to move the screen 100 vertically may be displayed on the screen 100. Alternatively, when sliding the screen 100 horizontally or vertically, the screen may move.

The display frames 101 to 104 each may have, for example, a quadrilateral shape but it should be noted that there is no limitation on a display shape.

The display frames 101 to 104 may display information on different external devices, respectively. As an example, information on a refrigerator may be displayed on the first display frame 101, information on an oven may be displayed on the second display frame 102, information on a washer may be displayed on the third display frame 103, and information on a dryer may be displayed on the fourth display frame 104.

The display frames 101 to 104 may also display information on similar devices. For example, when there are two refrigerators, information on a secondary refrigerator in addition to a primary refrigerator may also be displayed on the display frames 101 to 104.

The display unit 31 may display, on each of the display frames 101 to 104, both indication information 111 and 112 and state information 113 regarding the external devices.

The indication information 111 and 112 about each external device may be the name 111 of the external device or an icon 112 representing the external device.

The state information 113 of the external device may depend on a home appliance category.

As an example, when the home appliance is a refrigerator, the state information 113 may include one or more of the operational state of the refrigerator (i.e., is it turned on/off), the number of foods kept in a refrigerating compartment, the number of foods that have passed the expiration date/the number of all kept foods, the state or category of stored foods, a recommended dish, a defrosting state, a door open/closed state, a door fault state, a desired temperature and humidity for operation.

When the home appliance is an oven, the state information 113 may include one or more of the operational state of the oven (i.e., is it turned on/off), whether the oven is cooking or in a standby state, a remaining operation time period, information on whether the door of the oven is opened, a fault state, and a recommended dish.

When the home appliance is a washer or a dryer, the state information 113 may include one or more of an operational state of the washer or dryer (on/off state), information on whether the door of the washer or dryer is opened, a current operation course, a remaining operation time period, a desired temperature and humidity for operation, a fault state, and a recommended course.

When the home appliance is a robot cleaner, the state information 113 may include one or more of an operational state of the robot cleaner (on/off state), a current operation mode, a charged status, a battery state, and a fault state.

When the home appliance is a TV, the state information 113 may include one or more of an operational state of the TV (on/off state), whether a user is watching the TV, a current channel, volume, and a program name.

When the home appliance is an air conditioner, the state information 113 may include one or more of an operational state of the air conditioner (i.e., is it on/off), a current operation course, a desired temperature and humidity for operation, a remaining operation time period, an accumulated operation time period, information on whether the door of the air conditioner is opened, a fault state, a registration state, a recommended temperature, and a recommended mode.

When the home appliance is a lamp, the state information 113 may include one or more of the number of turned-on lamps, the number of turned-off lamps, and brightness information of turned-on lamps.

The above-mentioned state information 113 is only exemplary. Thus, it should be noted that anything for representing state information on the home appliance may be included and there is no limitation on the category of the information.

The state information 113 may include graphic information in addition to text information. The text information may include a character, a number, and a symbol. The graphic information may include a graph, a line, and a figure.

According to one embodiment, since state information as well as indication information on one or more communication-connected external devices are displayed on single screen, there is an advantage in that a user may easily check state information on the external devices.

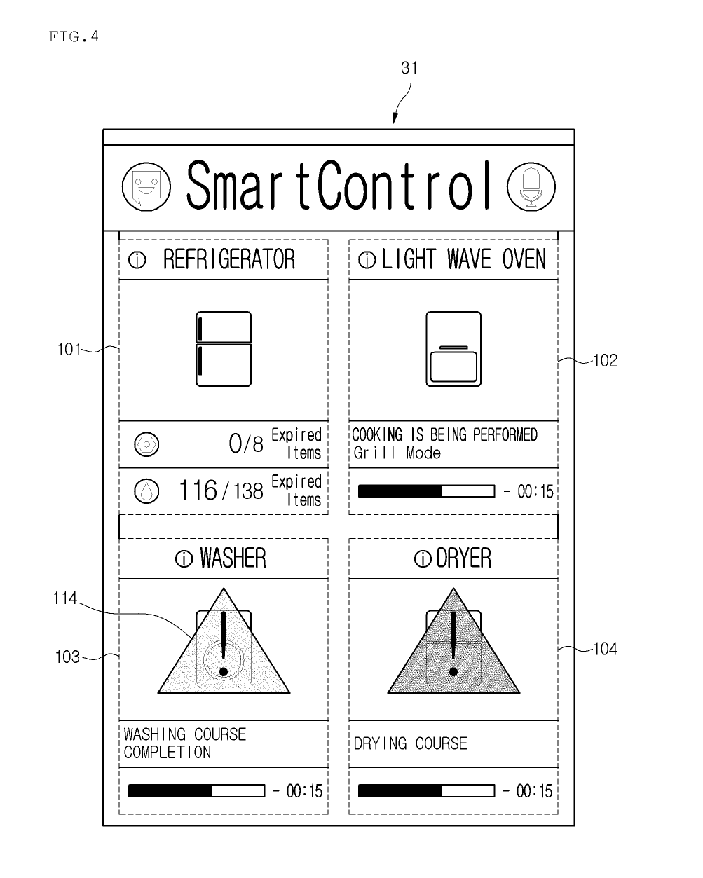

FIG. 4 illustrates how notice information for providing a notice of a state change on the screen of a display unit of one embodiment is displayed.

Referring to FIGS. 3 and 4, when the state of a specific one of communication-connected external devices displayed on the display unit 11 is changed, notice information 114 for providing a notice of a state change is displayed on a display frame corresponding to that specific external device.

For example, when the communication-connected external device is a washer and it is sensed that the door of the washer is opened, the notice information 114 may be displayed on the third display frame 103.

Specifically, the notice information 114 may be an icon or a symbol that is further displayed on the display frames 101 to 104. As an example, the notice information 114 may be displayed to overlap with the icons 112 of the display frames 101 to 104. Also, the state information on the display frames 101 to 104 may include content corresponding to the notice information. As an example, texts such as “Door is opened” may be displayed on the display frames 101 to 104.

The color, shape, or size of the notice information 114 may depend on the category of information for a notice. For example, the notice information 114 for providing a notice that a door is opened may have a yellow color, and the notice information 114 for providing a notice of a fault may have a red color.

The notice information 114 may disappear when a user touches corresponding notice information 114 or an region of each of the display frames 101 to 104 where the notice information 114 appears. Alternatively, the notice information 114 may automatically disappear when a certain time period passes after it is displayed on the display frames 101 to 104.

As another example, when the communication-connected external device is in an abnormal state, the notice information 114 may be displayed on one of the display frames 101 to 104 corresponding to that device. An abnormal state of the device may include when a door is opened or when a fault or an error occurs.

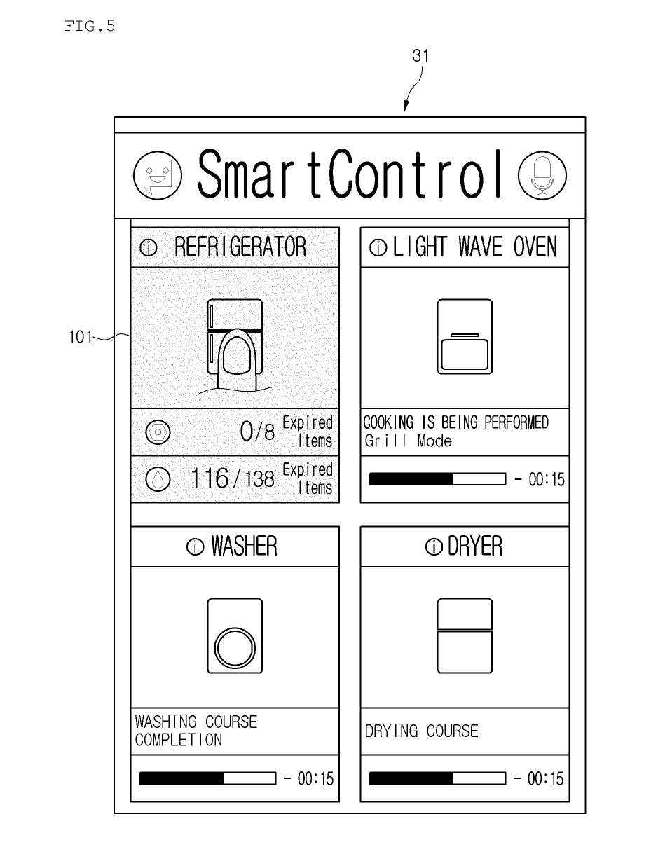

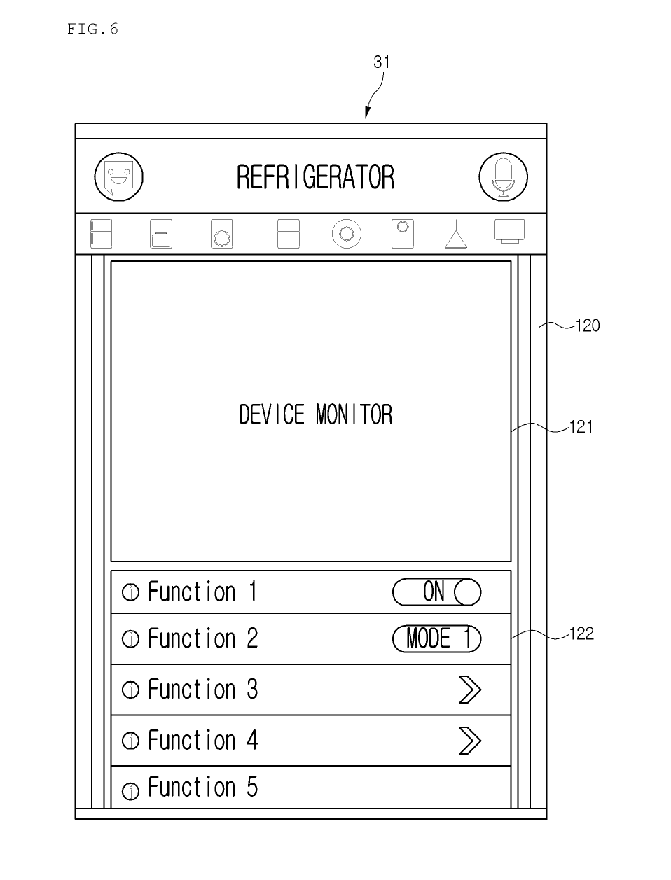

FIG. 5 illustrates how a specific display frame is selected from the screen of FIG. 3, and FIG. 6 illustrates a screen displayed on the display unit when the specific display frame is selected from FIG. 5.

Referring to FIG. 5, when any one component of information on external devices displayed on the display frames 101 to 104 of the screen 100 respectively is selected, a control screen 120 for controlling a device or a detailed information screen for providing detailed information on the device may be displayed on the display unit 31 as shown in FIG. 6.

Specifically, a user may touch a region of each of the display frames 101 to 104 on the screen 100. For example, when the user touches an region of the icon 112 of each of the display frames 101 to 104, the screen 100 may be switched to the control screen 120, or the control screen 120 may be popped up on the screen 100.

The control screen 120 may be divided into a state display region 121 where an icon or an image representing an external device is displayed, and an input region 122 for inputting a control command. Various states of the external device may be displayed in a text or graphic form on the state display region 121. A button for changing the operation condition or function of that external device may be displayed on the input region 122.

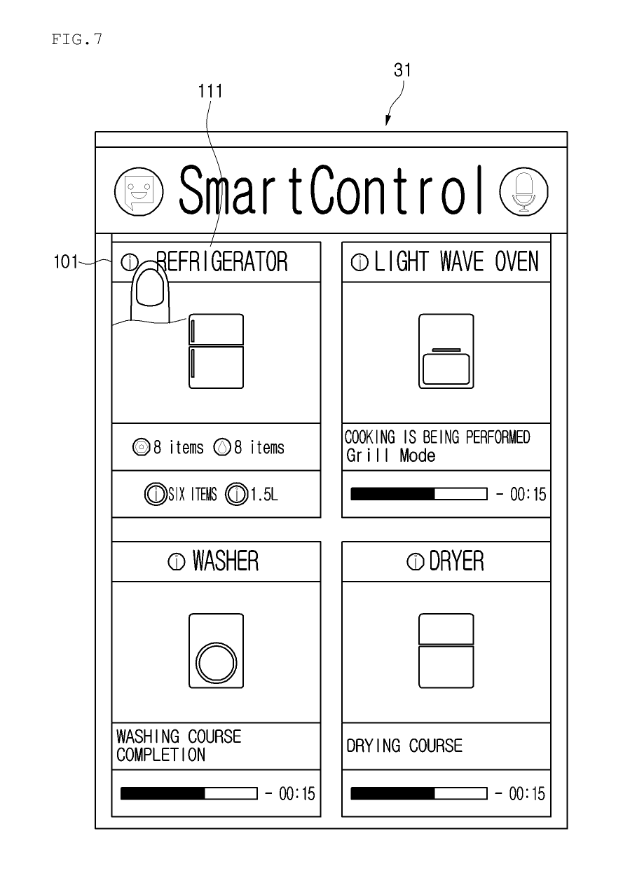

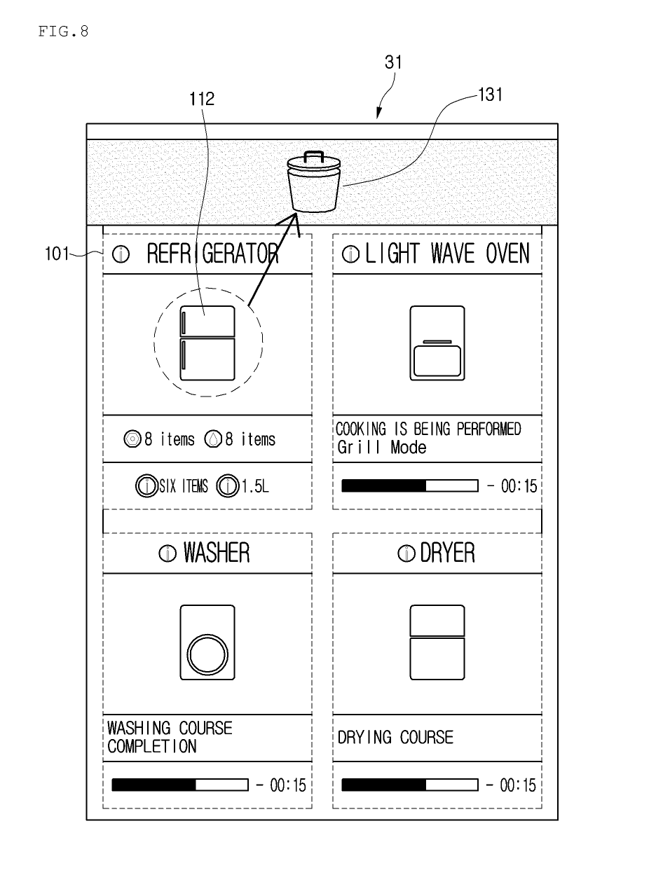

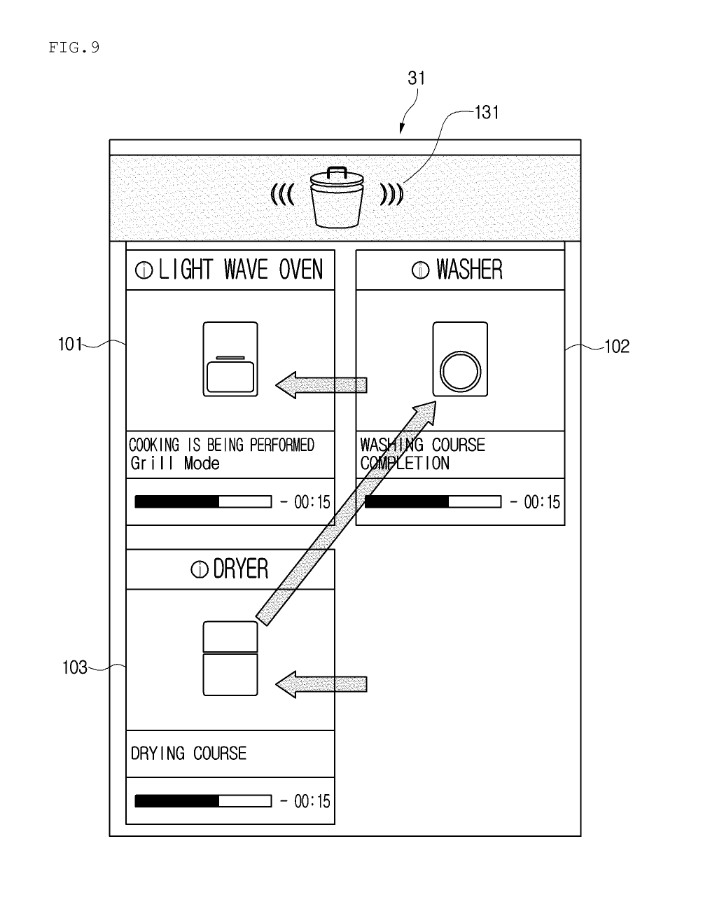

FIG. 7 illustrates how a specific display frame is touched for a certain time on the screen of a display unit of one embodiment of the present invention, FIG. 8 illustrates a screen displayed on a display unit when the specific display frame is touched in FIG. 7, and FIG. 9 illustrates a screen after a first display frame is deleted in FIG. 8.

Referring to FIG. 7, when a specific one of the display frames 101 to 104 is touched for a time equal to or greater than a certain value, the display unit 31 displays a delete screen 131 for deleting information on that display frame (a delete screen is activated) as shown in FIG. 8.

As another example, when an region displaying the name 111 of a device or a region displaying an icon 112 on a specific one of the display frames 101 to 104 is touched, the delete screen 131 may be displayed on the display unit 31.

The delete screen 131 corresponds to a part that is formed by the change of a part of the screen 100 in FIG. 7. The delete screen 131 may include a dustbin icon, for example.

As an example, after the first display frame 101 on the first display region is touched, if it is dragged to the dustbin icon the first display frame 101 is deleted.

Referring to FIG. 9, if the first display frame 101 is deleted from the first display region, the second display frame 102 may move from the second display region to the first display region as indicated by arrow, the third display frame 103 may move from the third display region to the second display region, and the fourth display frame 104 may move from the fourth display region to the third display region.

In the case of such an embodiment, it may be understood that a display frame may be moved, added, or deleted while information displayed on a display frame is maintained.

As another example, the display region itself may be a display frame. In this case, when a specific display frame is dragged into a dustbin icon after the display frame is touched, information displayed on that display frame is deleted.

Then, information displayed on the first display frame 101 may disappear as shown in FIG. 9 and information (e.g., on an oven) previously displayed on the second display frame 102 may be displayed on the first display frame 101. Also, information (e.g., on a washer) previously displayed on the third display frame 103 may be displayed on the second display frame 102.

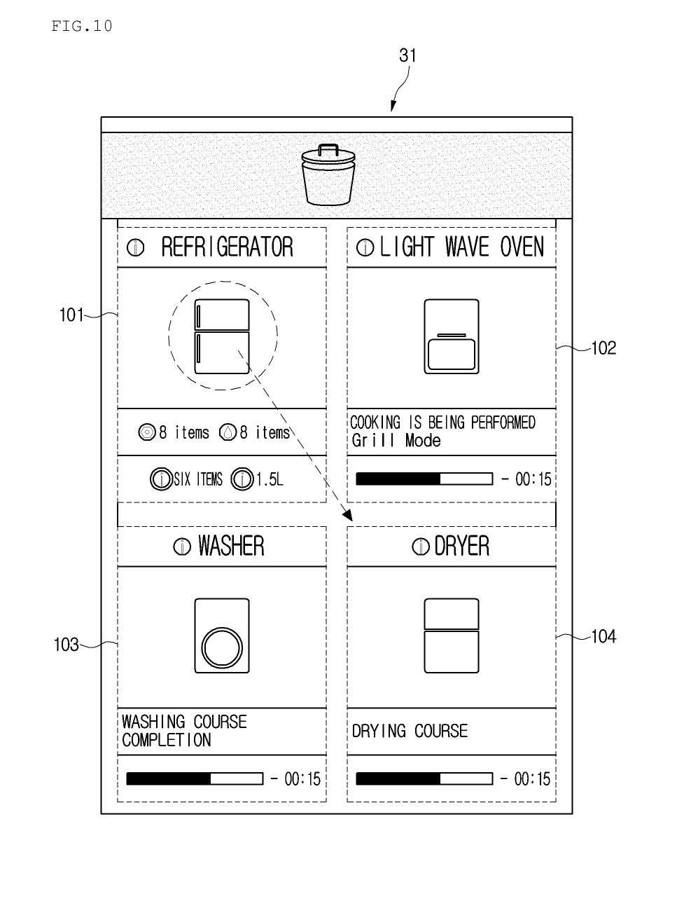

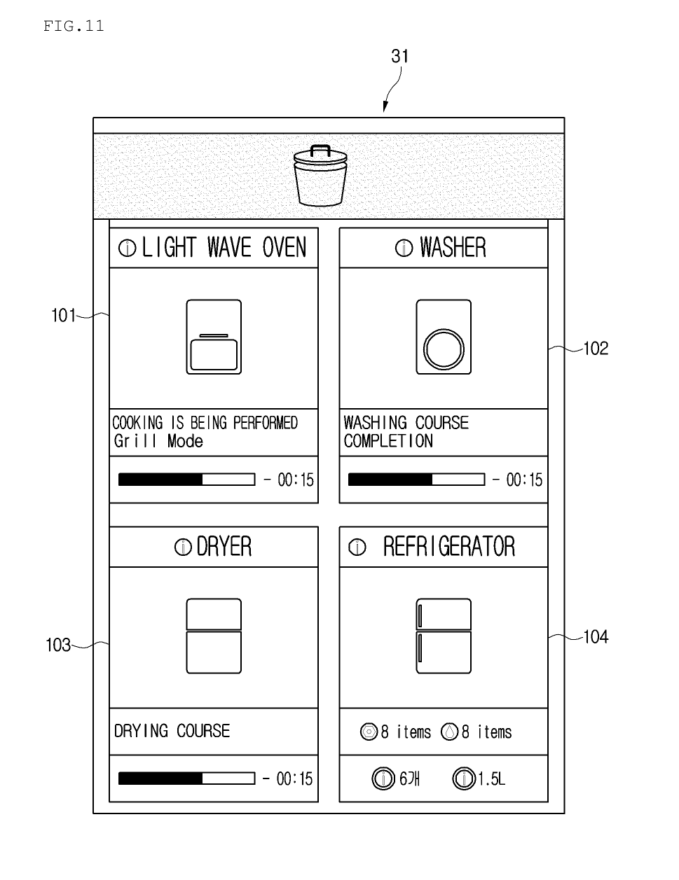

FIGS. 10 and 11 illustrate how the locations of display frames displayed on a display unit of one embodiment are changed.

Referring to FIG. 10, it is possible to change the locations of the display frames 101 to 104 on the screen of the display unit 31.

For example, when a region of the first display frame 101 is touched and then the first display frame 101 is dragged toward the fourth display frame 104, the locations of display frames are changed as shown in FIG. 11. That is, the first display frame 101 moves to the fourth display region, the second display frame 102 moves to the first display region, the third display frame 103 moves to the second display region, and the fourth display frame 104 moves to the third display region.

That is, in one embodiment, when a display frame to be moved is moved to a target region, a display frame on that target region and display frames on display regions having a number lower than that of the target region move.

For example, in one embodiment, the left upper part takes a first place, the right upper part takes a second place, the left lower part takes a third place, and the right lower part places a fourth place, and a display frame moves to a display region that has a number lower than the current number.

If the first display region 101 in FIG. 10 is moved to the second display region, the second display frame 102 is moved to the first display region and the first display frame 101 is moved to the second display region. In this case, the third display frame 103 and the fourth display frame 104 are not moved.

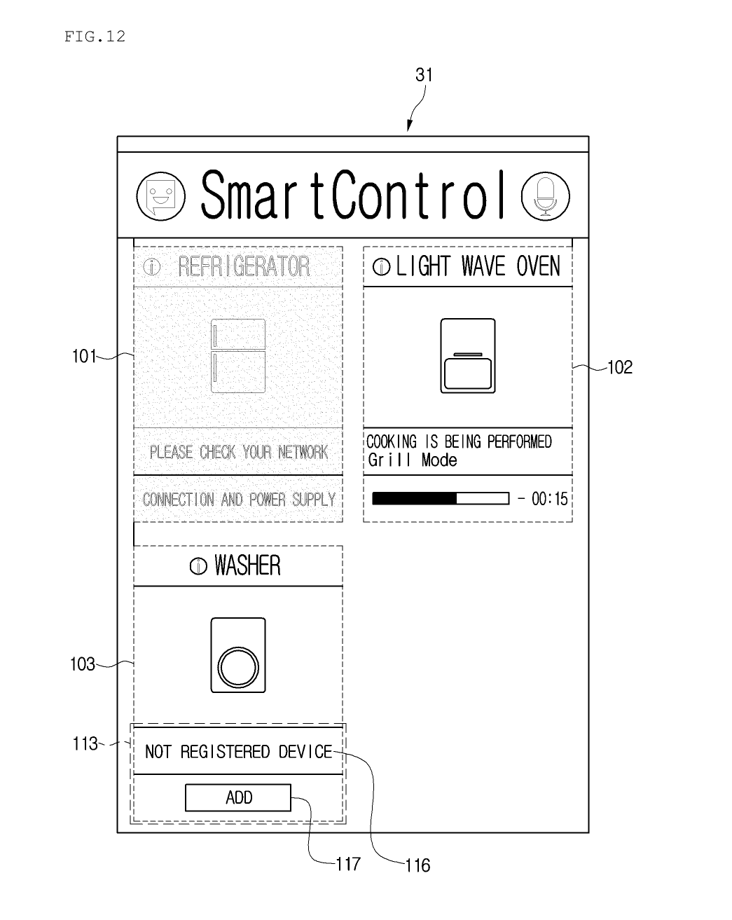

FIG. 12 illustrates a screen displayed on a display unit when there is a communication-disconnected device or a communication-disabled device.

Referring to FIG. 12, when an external device having been displayed on the display unit 31 is communication-disconnected or communication-disabled after having been communication-connected (e.g, the refrigerator), a display frame displaying information on that device may be distinguished from a display frame displaying information on a communication-connected device. As an example, the display frame having displayed information on the communication-disconnected device may be changed in color, be unclearly displayed, or be inactivated. Alternatively, a display frame having displayed information on a communication-disconnected device may disappear from the display unit 31.

On the other hand, a display frame of the display unit may display information on a communication-connected device that is not registered. As an example, state information 113 on the display frame may include text information 116 providing a notice that a corresponding device is an unregistered device, and a button 117 to be selected for registration. In addition, after the button 117 is pressed and information (such as, a product code, a user id, or password) on that device is registered, the display unit 31 may display state information on that device when the registered device is communication-connected.

That is, in the case of one embodiment, when an external device is communication-connected and when information on an external device is registered on the display unit 31, state information on an external device displayed on the display unit 31 may be displayed.

Thus, when a device is communication-connected but not registered, the display unit 31 may display only indication information and not state information.

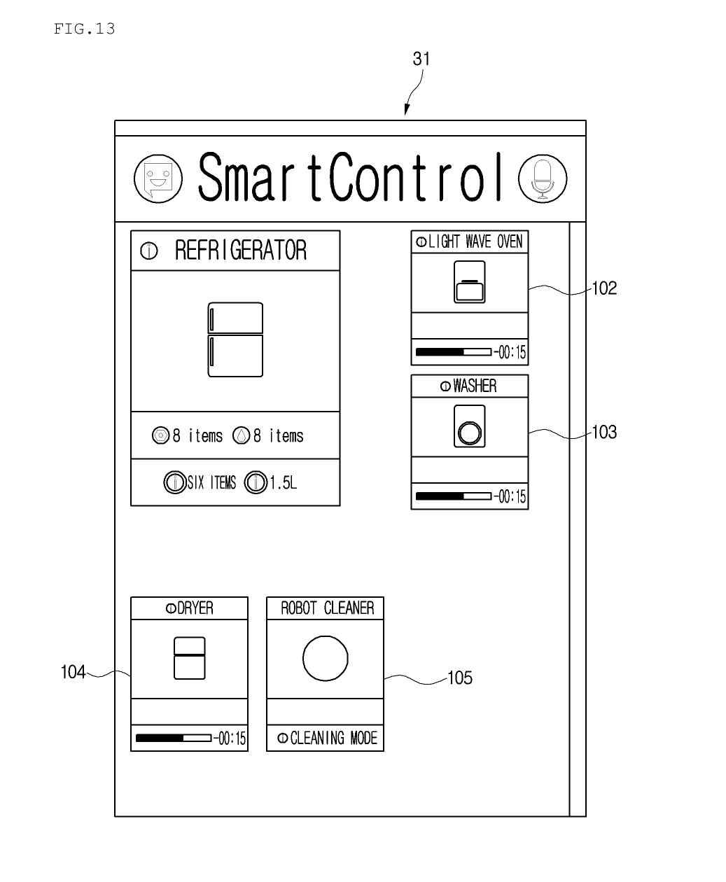

FIG. 13 is another example of a display screen displayed on a display unit of a home appliance according to one embodiment of the present invention.

Referring to FIG. 13, when the number of communication-connected external devices to a home appliance exceeds a reference number, the size of at least one of a plurality of display frames displayed on the display screen may be maintained and the sizes of the others may decrease.

For example, the size of the first display frame 101 is maintained, the sizes of the second to the fourth display frames 102 to 104 decrease, and a fifth display frame 105 is added to the display screen.

In this case, on the display screen, it is also possible to display the size of the added display frame 105 with a certain size and decrease the sizes of previously displayed display frames. Alternatively, it is also possible to maintain the size of the display frame on the first display region and decrease the sizes of the display frames displayed on the other display regions.

As another example, when the number of communication-connected external devices to a home appliance exceeds a reference number, the size of the display frame displayed on the display screen may decrease in proportion to an exceeding level of the reference number. For example, when the number of the communication-connected external devices does not exceed the reference number, display frames of the same size may be displayed on the display screen. In addition, when the number of the communication-connected external devices exceeds the reference number, the size of the display frames displayed on the display screen may decrease. In this case, the size of all display frames may equally decrease.

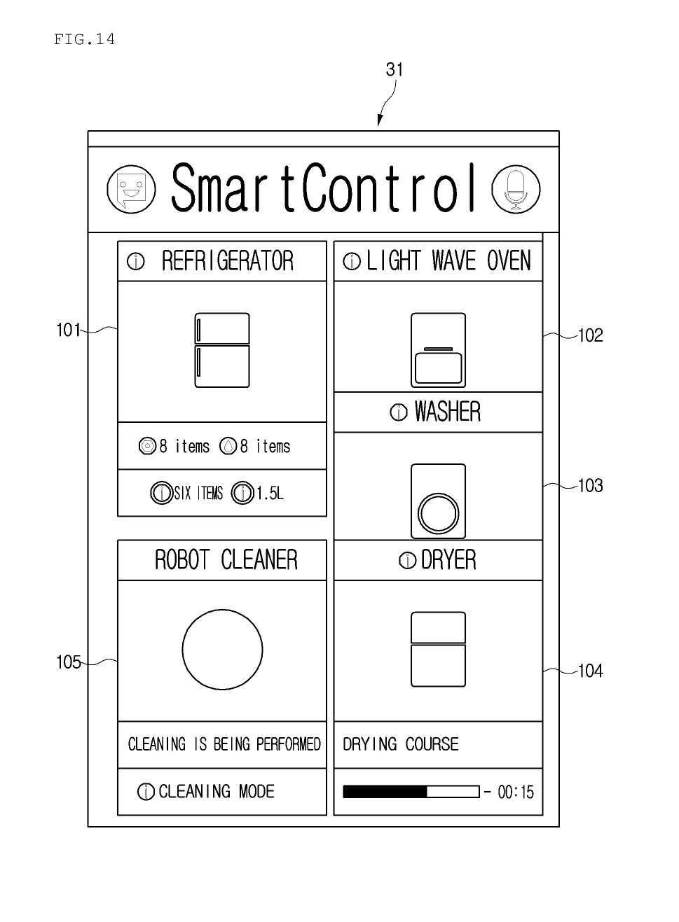

FIG. 14 is still another example of a display screen displayed on a display unit of a home appliance according to one embodiment of the present invention.

Referring to FIG. 14, when the number of communication-connected external devices to a home appliance exceeds a reference number, some of a plurality of display frames displayed on the display screen may overlap with one another. However, in order to enable a user to check which external devices the display frames displayed on the display screen represent, the display frames may not cover at least indication information on the external devices.

Although the above embodiment describes the screen displayed on the display unit 31 of a home appliance, the above-described screen may also be displayed on the display unit of the mobile terminal 16. That is, the mobile terminal 16 may also include a communication unit for communicating with a home appliance, a display unit that performs the same function as the display unit of the above-described home appliance and may display the same information, and a control unit that controlling the display unit.

FIG. 15 is an example of a main screen of a display screen displayed on a display unit of a home appliance according to one embodiment of the present invention.

Referring to FIG. 15, a main screen 200 may be displayed on the display unit 31 of the refrigerator 11 according to one embodiment. As an example, the main screen 200 may be a screen displayed for the first time when the refrigerator 11 is turned on.

A widget 201 may be displayed on the main screen 200. Also, a function management option 211 to 219A for function management may be further displayed on the main screen 211. The function management option may include one or more of a option 211 for selecting a food management function, a option 212 for checking or generating recipe, a option 213 for purchasing desired food, a option 214 for managing family's health or diet, a option 215 for checking information on the content of a communication-connected external device or for outputting the content, a option 216 for selecting a memo function, a option 217 for managing schedules, a option 218 for selecting a power-saving function, a option 219 for setting the operation of the display unit or the function of the refrigerator, and a option 219A for setting a smart control function capable of monitoring or controlling information on an external device. The function management option displayed on the main screen 200 in the present embodiment may depend on a home appliance category.

However, the option 215 for checking information on the content of the communication-connected external device or for outputting the content may be displayed on the main screen or a specific screen.

In the following, a case where the option 215 (also referred to as “a smart share option”) for checking information on the content or outputting the content is selected on the main screen in FIG. 15 is described.

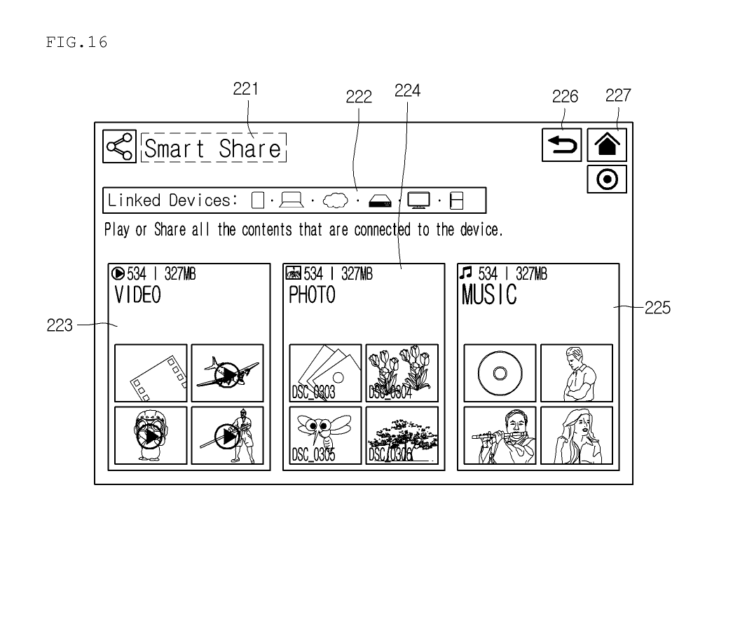

FIG. 16 illustrates an example of a display screen displayed on a display unit when a smart share option is selected from the screen of FIG. 15.

Referring to FIG. 16, the display unit 31 of a home appliance according to one embodiment of the present invention, such as of refrigerator 11 may display information on content that one or more external devices connected to a display screen retain.

In particular, category information 222 on a communication-connected external device may be displayed on a first display region of the display screen. The category information 222 may include name information on the external device or icon information representing the external device.

Additionally, content file information 223 to 225 may be displayed on a second display region separated from the first display region, on a content category basis.

On the second display region, information on all video files 223, information on all photo files 224, and information on all music files 225 that a communication-connected external device and a home appliance itself retain may be displayed separately. Each of the file information 223 to 225 functions as a root folder. Thus, the display screen of FIG. 16 may depict that folders are aligned and displayed on a content category basis.

The display screen of FIG. 16 may display information on a selected function 221, a back button 226 for moving to the previous screen, and a home button 227 for returning to the main screen.

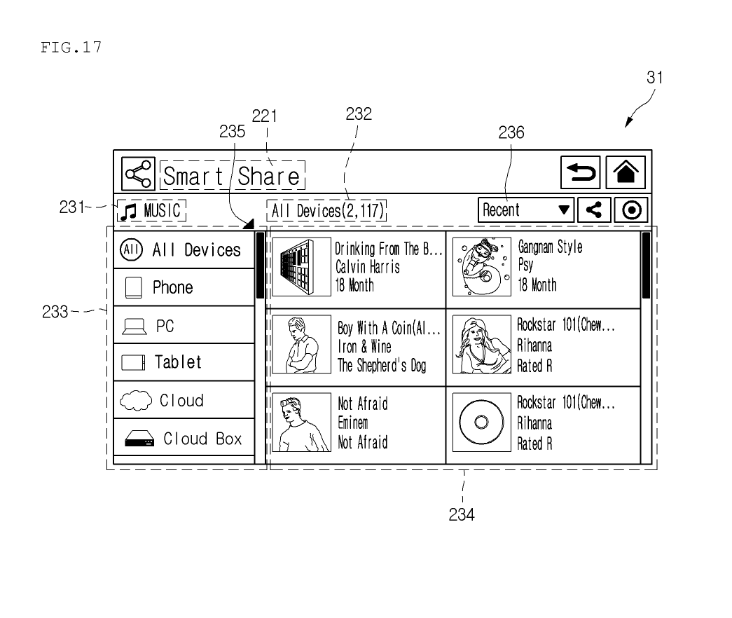

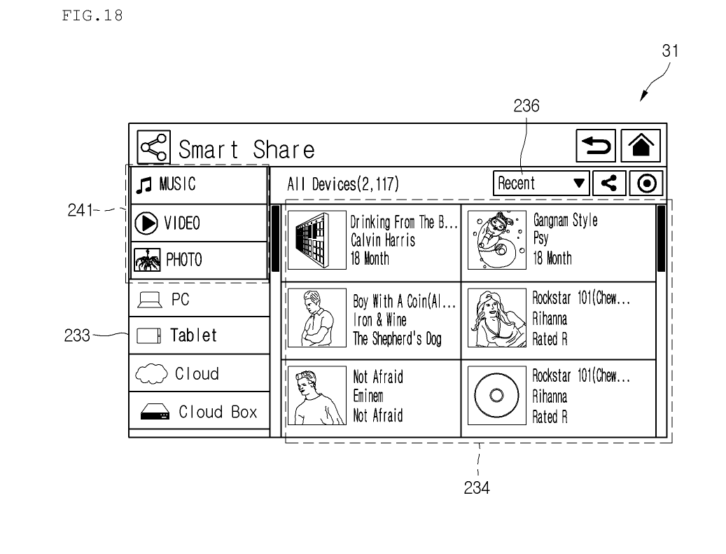

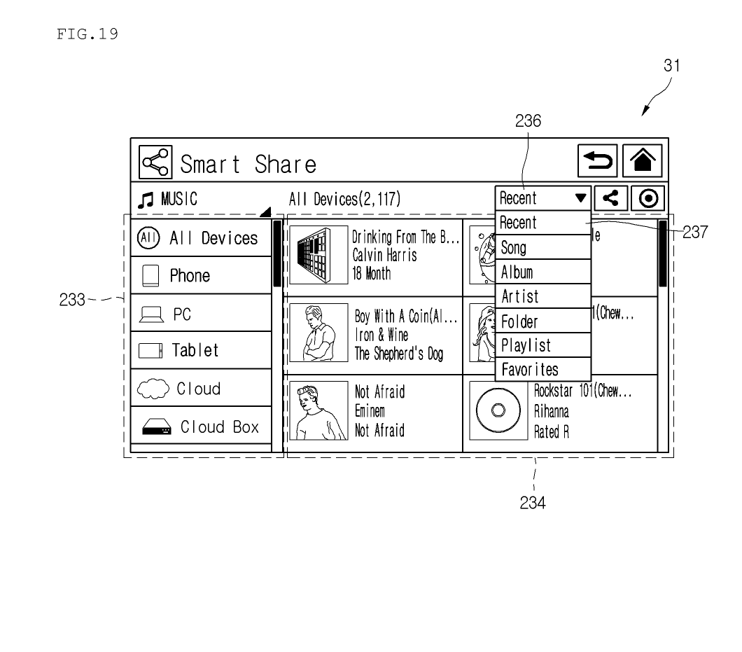

FIG. 17 is an example of a display screen displayed on a display unit when music file information is selected from the display screen of FIG. 16, FIG. 18 illustrates how a selection window is displayed on a display screen when content type information is selected from FIG. 17, and FIG. 19 illustrates how a selection window is displayed on a display screen when an alignment selection button is selected from FIG. 17.

Referring to FIG. 17, the display screen may include a first display region 233 and a second display region 234 that are separated from each other.

The first display region 233 may display device category information representing the category of a communication-connected external device.

The device category information may include all device information that may select all the devices, along with individual device information to be able to select a communication-connected external device. The individual device information and the all device information may be displayed separately and a user may select any one component of the displayed individual device information or the displayed all device information.

Also, the individual device information may include the name of the communication-connected external device or icon information representing the communication-connected external device.

The device category information provides the basis of information to be displayed on the second display region 234. That is, when a specific external device is selected from the device category information, the second display region 234 may display a list of content files that the selected external device retains.

Alternatively, when all the devices are selected from the device category information, the second display region 234 may display a list of content files that all communication-connected external devices retain. In case that a component configuring the file list is a folder, when the file is selected, sub-information on the selected file may be displayed on the display screen.

That is, only a file name transmitted from the external device is displayed on the display screen, and when content in the file is selected, corresponding content may be received from corresponding external device.

A third display region other than the first display region 233 and the second display region 234 of the display screen may display content category information 231 representing the category of content displayed currently on the second display region 234, and information 232 on a device (that is, information selected from the device category information of the first display region) that retains content displayed on the second display region 234. The information 232 may include the name of a device and the number of content items that the device retains.

A user may select the content category information 231 on the display screen and change the category of content to be displayed on the second display region 234.

For example, if a user selects the content category information 231 on the screen of FIG. 17, a selection window 241 for selecting the category of content is activated as shown in FIG. 18. In this case, the selection window 241 separately displays individual information capable of selecting the category of content (music, video, photo, device driving information, device state information, device management information, etc.). Additionally, a user may select any one component of individual information representing a content category displayed on the selection window 241. In one embodiment, the device driving information means information on a course driven until now by an external device, the device state information means whether the device is in a normal or abnormal state, and the device management information means information on a function managed by the device, such as food management, recipe management, or shopping management.

The third display region may further display an alignment selection button 236 for selecting a basis to align a list of content files displayed on the second display region 234.

A user may select the alignment selection button 236 on the display screen and change how to align content to be displayed on the second display region 234. For example, if a user selects the alignment selection button 236 on the screen of FIG. 17, a selection window 237 for selecting an alignment basis is activated as shown in FIG. 19. Specifically, the selection window 237 separately displays individual basis information for aligning content (such as file name, album name, singer name, file update time). Additionally, a user may select any one component of individual reference information displayed on the selection window 236.

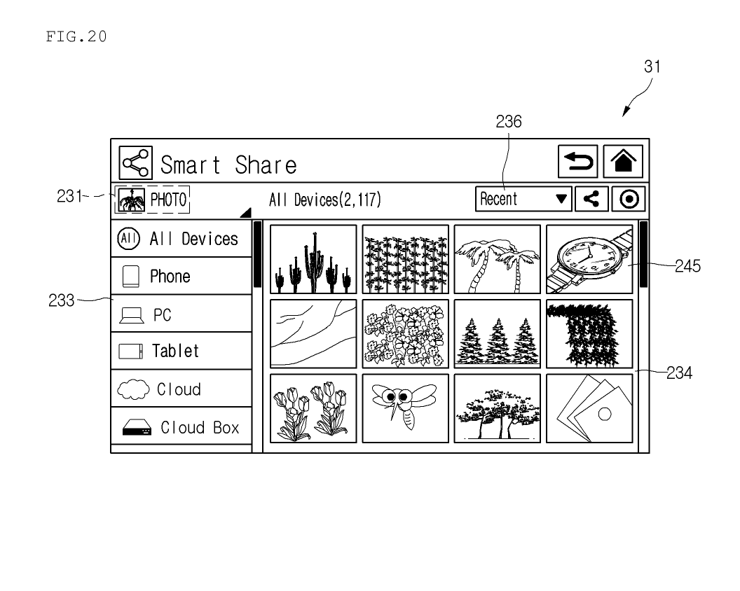

FIG. 20 is an example of a display screen displayed on a display unit when a photo is selected from a selection window displayed on the screen of FIG. 18.

Referring to FIGS. 18 and 20, when e.g., a photo is selected from the selection window 241 displayed on the screen of FIG. 18, the second display region 234 may display a list of photo files among content that all external devices retain.

In this case, even if the category of content is changed, the category of an external device that retains content may maintain the previous state. That is, even if the category of content is changed while a list of content files that all external devices retain is displayed on the screen of FIG. 18, the list of content files that all external devices retain is displayed on the changed screen and only the category of displayed content is changed.

Referring to FIG. 20, the second display region 234 displays a list of photo files for all devices. A plurality of photo frames 245 may be displayed on the second display region 234 and a portion or a whole of a corresponding photo may be displayed on each photo frame 245.

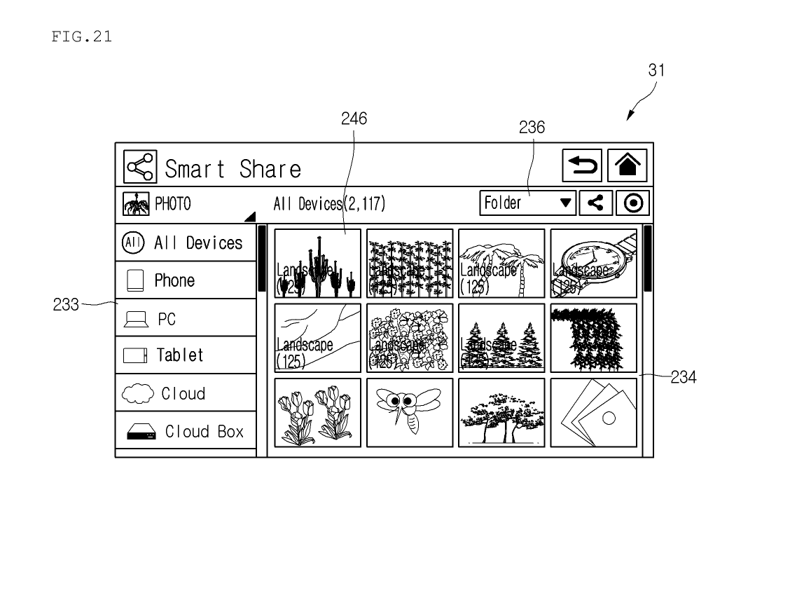

FIG. 21 illustrates when a second display region of a display screen is aligned by folder.

Referring to FIG. 21, when e.g., alignment by folder is selected by the alignment basis button 236, the second display region 234 may display one or more photo folders 246. Each photo folder 246 may display the number of photos that belong to a corresponding folder. In addition, a portion or a whole of an icon representing the photo folder 246 may display a portion or a whole of one of photos that belong to that photo folder. In this case, when a specific photo folder 246 displayed on the second display region in FIG. 21 is selected, photo frames that belong to a corresponding folder may be displayed on the second display region as shown in FIG. 20.

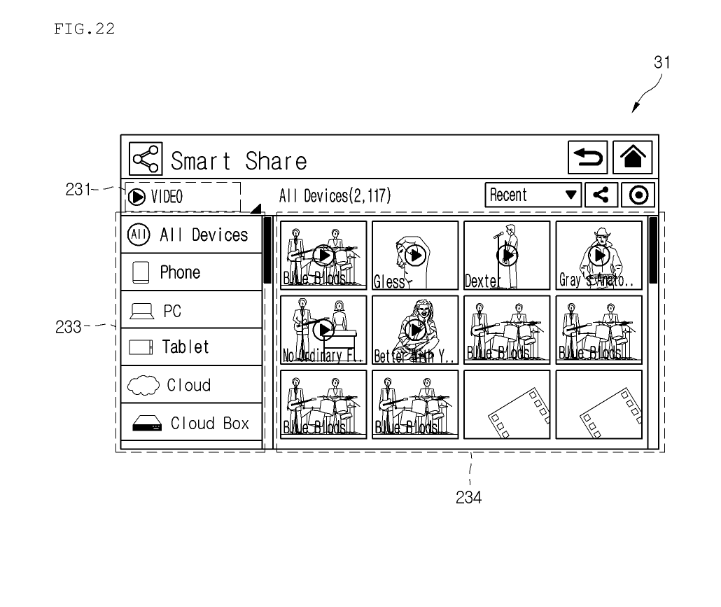

FIG. 22 is an example of a display screen displayed on a display unit when a video is selected from a selection window displayed on the screen of FIG. 18.

Referring to FIGS. 18 and 22, when e.g., a video is selected from the selection window 241 displayed on the screen of FIG. 18, the second display region 234 may display a list of video files among content that all external devices retain.

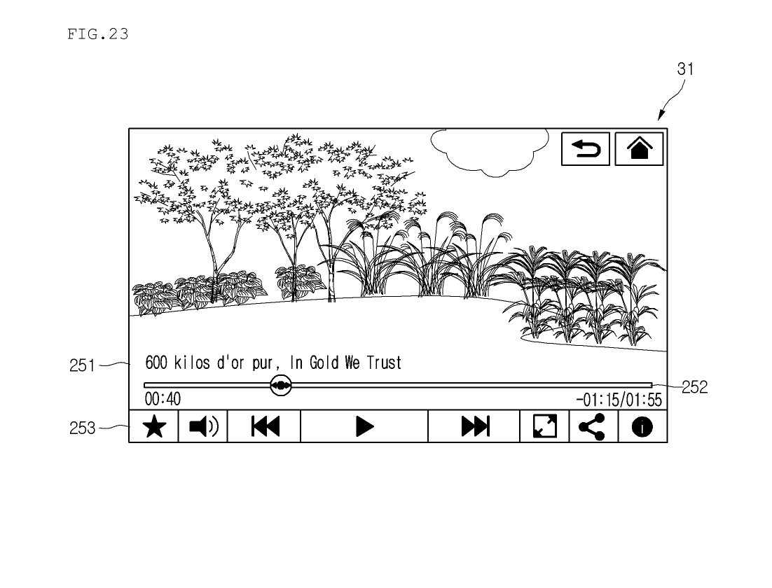

FIG. 23 illustrates how a video is displayed on a display screen.

Referring to FIG. 23, a video may be played on the display screen. Specifically, the name of a video file 251, information on a played time 252, and a plurality of buttons 253 for function selection may be displayed on the display screen.

In one embodiment, when the selected video is stored in the memory 34, the video stored in the memory 34 is displayed on the display screen. On the other hand, when the selected video is a video stored in an external device, the communication unit receives a video from the external device that retains the selected video, and the display unit displays the received video on the display screen.

As another example, when the selected video is a video stored in an external device, the communication unit receives the video from the external device retaining the selected video and stores the received video in the memory 34, and the display unit may display, on the display screen, the video stored in the memory 34.

Also, while a video is displayed on the display screen, the remaining part of the video may be displayed on the display units of other external devices. Alternatively, the remaining part of the video being displayed on the other external devices may be displayed on the display screen. That is, video display information may be shared between home appliances and parts not displayed on a specific home appliance may be displayed on other home appliances.

Also, if communication is disabled or disconnected while receiving a video file from an external device, an icon or text information representing the video file being received may be inactivated.

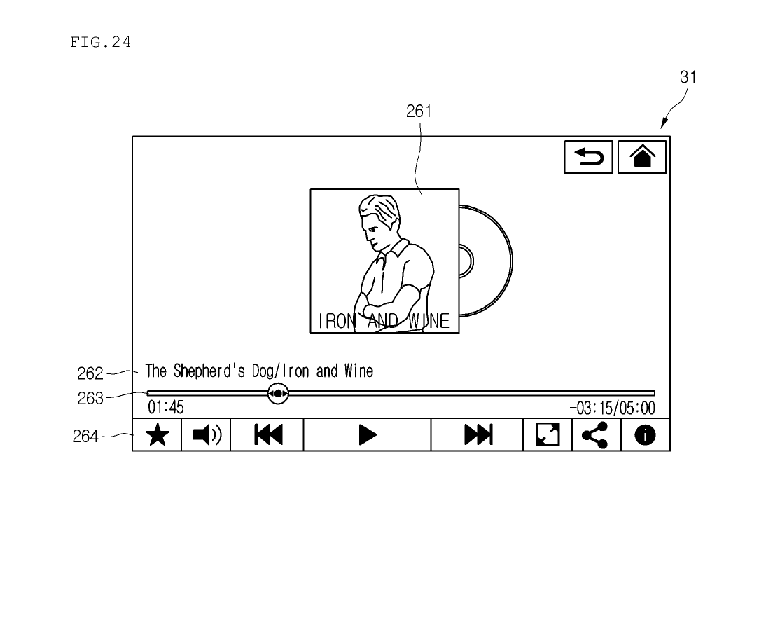

FIG. 24 illustrates how music file information is displayed on a display screen.

Referring to FIG. 24, if a specific music file is selected on the screen of FIG. 18 or 19, music may be output from a speaker (not shown), and selected music file information may be displayed on the display screen. As an example, the display screen may display photo information related to a selected music file (album information 261), a selected music file name 262, played time information 263, and a plurality of buttons 264 for function selection.

In one embodiment, when the selected music file is stored in the memory 34, the music file stored in the memory 34 is executed on the display screen. On the other hand, when the selected music file is a music file stored in an external device, the communication unit receives a music file from the external device that retains the selected music file, and the speaker (output unit) plays the music file.

As another example, when the selected music file is a music file stored in an external device, the communication unit receives a music file from the external device that retains the selected music file and store the received music file in the memory 34, and the speaker (output unit) plays the music file stored in the memory 34.

Also, while a music file is executed on the display screen, the remaining part of the music file may be outputted from the speakers of other external devices. That is, execution information on a music file may be shared between home appliances and parts not output from a specific home appliance may be output from other home appliances.

Also, if communication is disabled or disconnected while receiving a music file from an external device, an icon or text information representing the music file being received may be inactivated.

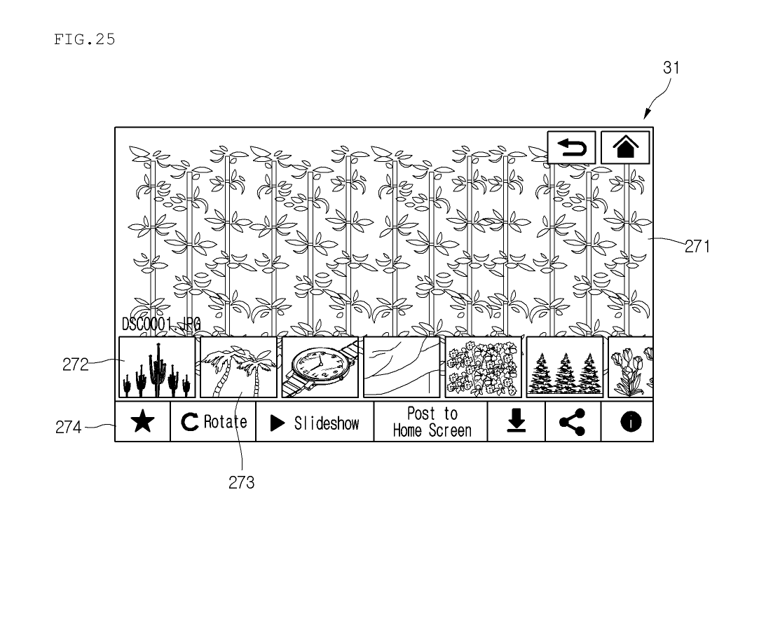

FIG. 25 illustrates how a photo is displayed on a display screen.

Referring to FIG. 25, if a specific photo file in FIG. 20 is selected, the display screen displays the selected photo.

Frames 272 and 273 displaying photos to be displayed following a photo currently displayed are displayed on the lower part the photo 271 displayed on the display screen. As another example, a frame displaying a reduced version of the currently displayed photo on the lower part of the currently displayed photo 271 and a frame displaying a photo to be displayed following the currently displayed photo may be displayed.

Also, the display screen may display a plurality of buttons 274 for function selection.

In one embodiment, when the selected photo file is stored in the memory 34, the photo stored in the memory 34 is displayed on the display screen. On the other hand, when the selected photo file is a file stored in an external device, the communication unit receives a photo file from the external device retaining the selected photo file and stores the received photo file in the memory 34, and the display unit may display, on the display screen, the photo file stored in the memory 34.

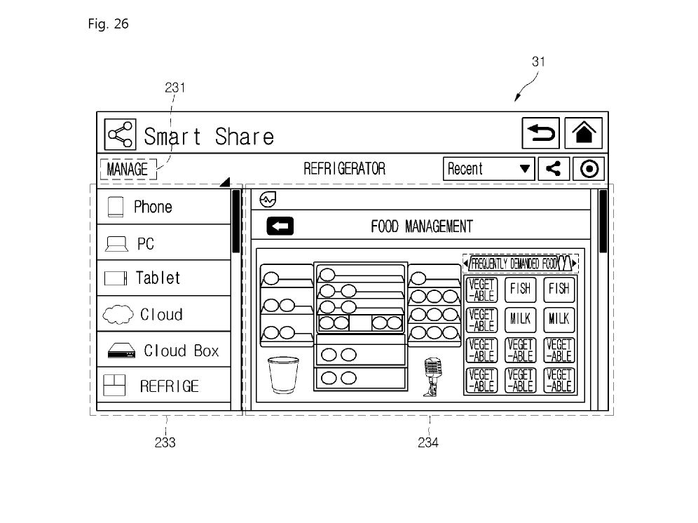

FIG. 26 is an example of a display screen displayed on a display unit when a refrigerator is selected from a first display region displayed on the screen of FIG. 17.

Referring to FIG. 26, when a refrigerator (which is an example of an external device) is selected on the first display region displayed on the screen of FIG. 17, a second display region may display information (screen) for food management as an example of device management information.

As described above, content category information 231 for selecting the category of content is selected on the display screen, information displayed on the second display region may be changed.

For example, when the external device selected on the first display region is a refrigerator, the content category may be device driving information, device state information, device management information, etc.

When the external device selected on the first display region is a washer, the content category may be device driving information, device state information, etc.

According to one embodiment proposed, since even if a specific home appliance does not retain content, it may output content that a communication-connected external device retains, there is an advantage in that it is possible to save a memory of the specific home appliance.

Also, since a specific home appliance may output content that a communication-connected external device retains, there is an advantage in that it is possible to check information on content and output content even if a user does not manipulate the external device that retains content.

Although the above embodiment describes the screen displayed on the display unit 31 that is an example of an output unit, the above-described screen may also be displayed on the output unit of the mobile terminal 16. That is, the mobile terminal may also include a communication unit for communicating with a home appliance, an output unit that performs the same function as the display unit of the above-described home appliance and may provide the same information, and a control unit that controls the output unit.

Although embodiments have been described with reference to a number of illustrative embodiments thereof, it should be understood that numerous other modifications and embodiments can be devised by those skilled in the art that will fall within the spirit and scope of the principles of this disclosure. More particularly, variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A home appliance comprising:
a communication unit to connect and communicate with external devices;
a display unit to display, on a display screen, information about an external device, among the external devices, which is in communication with the communication unit; and
a control unit to control the display unit.

2. The home appliance of claim 1, wherein the display screen is divided into two or more display regions, and the display unit displays information on an external device in communication with the communication unit on each of the display regions.

3. The home appliance of claim 3, wherein the display unit displays indication information and state information on the external device in communication with the communication unit together on each of the display regions.

4. The home appliance of claim 2, wherein the information displayed on each display region is changed.

5. The home appliance of claim 1, wherein the display unit displays a plurality of display frames on the display screen and displays information on an external device in communication with the communication unit on each display frame.

6. The home appliance of claim 5, wherein each display frame displays together indication information and state information on the external device in communication with the communication unit.

7. The home appliance of claim 6, wherein the display information is the name of the external device or an icon representing the external device.

8. The home appliance of claim 6, wherein the state information includes one or more of an operation state of the external device, a current operation course, a desired temperature or humidity for operation, a remaining operation time period, a state or number of stored foods, information on whether a door is opened, a fault state, a registration state, a charged state, a battery state, a recommended course, and a recommended dish.

9. The home appliance of claim 5, wherein when the state of the external device is changed, the display frame displays notice information that provides a notice of state change.

10. The home appliance of claim 5, wherein when a portion of the display frame is touched, the display screen displays a control screen for controlling an external device displayed on the touched display frame or a detailed information screen for showing external detailed information.

11. The home appliance of claim 5, wherein when a portion of the display frame is touched for a certain time, a delete screen for deleting information on a corresponding display frame is activated on the display screen.

12. The home appliance of claim 5, wherein when one or more of the external devices in communication with the communication unit are disabled or disconnected, the display screen displays a display frame displaying information on the external device in communication with the communication unit and a display frame separately displaying information on a disabled or disconnected external device.

13. The home appliance of claim 5, wherein when one or more of the connected external devices in communication with the communication unit are disabled or disconnected, information on the disabled or disconnected external device disappears from the display screen.

14. The home appliance of claim 5, wherein the locations of the display frames displayed on the display screen are changed.

15. The home appliance of claim 5, wherein the sizes of some or all of the display frames displayed on the display screen are changed.

16. The home appliance of claim 5, wherein at least some of the display frames displayed on the display screen overlap with one another.

17. The home appliance of claim 1, wherein the display unit displays, on the display screen, information on the home appliance along with information on the external device in communication with the communication unit.

18. The home appliance of claim 1, wherein the display unit displays, on the display screen, information on content that the external device in communication with the communication unit retains.

19. The home appliance of claim 18, wherein the display unit displays information on the external device in communication with the communication unit on a first display region of the display screen, and displays information on a content file on a content category basis on a second display region or displays a list of files of content corresponding to a specific content category.

20. The home appliance of claim 19, further comprising:
a memory to store content for display on the display unit, wherein file information on content or a list of files of content displayed on the display unit includes information on content stored in the memory and information on content that the external device in communication with the communication unit retains.

21. The home appliance of claim 19, wherein the first display region displays the name of the external device in communication with the communication unit or an icon representing the external device in communication with the communication unit.

22. The home appliance of claim 19, wherein when any one of the list of files of content displayed on the second display region is selected, sub-information on selected content is displayed.

23. The home appliance of claim 19, wherein a third display region of the display screen displays content category information displaying the category of content displayed on the second display region.

24. The home appliance of claim 23, wherein when the content category information is selected, a selection window for changing the content category is activated.

25. The home appliance of claim 24, wherein the content category information being selected through the selection window includes one or more of a video, music, and a photo that the external device selected on the first display region retains, and driving information, state information, and management information on the selected external device.

26. The home appliance of claim 19, wherein the third display region of the display screen displays an alignment selection button for selecting an alignment basis of content displayed on the second display region.

27. The home appliance of claim 19, wherein the third display region of the display screen displays the number of content items that any one or all of the external devices in communication with the communication unit retain.

28. The home appliance of claim 18, wherein when content displayed on the display screen is selected, the communication unit receives content from an external device that retains the selected content, and the display unit displays the received content.

29. The home appliance of claim 27, wherein when communication is disabled or disconnected while the content is being received from the external device, information or an icon representing the content being received is inactivated.

30. The home appliance of claim 18, wherein the communication unit receives information on content being output from the external device and the display unit continues to display the remaining part of the content output from the external device.

31. The home appliance of claim 18, wherein when content displayed on the display screen is selected, the communication unit receives content from the external device retaining the selected content and stores the received content in a memory, and the display unit displays the content stored in the memory.

32. A mobile terminal comprising:
a communication unit to connect and communicate with external devices;
a display unit to display, on a display screen, information about an external device, among the external devices, which is in communication with the communication unit; and
a control unit to control the display unit.
